(19) United States
(12) Patent Application Publication
(10) Pub. No.: US 2014/0226238 A1
(43) Pub. Date: Aug. 14, 2014

(54) DISK DRIVE UNIT

(71) Applicant: Samsung Electro-Mechanics Japan Advanced Technology Co., Ltd., Shizuoka (JP)

(72) Inventors: Takashi IKEDA, Shizuoka (JP); Masato Morimoto, Shizuoaka (JP)

(73) Assignee: Samsung Electro-Mechanics Japan Advanced Technology Co., Ltd., Shizuoka (JP)

(21) Appl. No.: 14/157,583

(22) Filed: Jan. 17, 2014

(30) Foreign Application Priority Data
Feb. 13, 2013 (JP) 2013-026025

(51) Int. Cl. G11B 19/20

(52) U.S. Cl. CPC G11B 19/2045
USPC 360/99.12

(57) ABSTRACT

A disk drive unit includes a base, a hub rotatably supported on the base and including a setting part on which a recording disk is to be set, and a bearing unit having one end fixed to the base and another end holding the hub. The hub includes a cut surface formed by cutting a nonferrous metal or a steel material, and the cut surface includes a surface treatment layer formed thereon and preventing peeling of micro residue adhered on the cut surface.

### CROSS-REFERENCE TO RELATED APPLICATIONS

This application is based upon and claims the benefit of priority of Japanese Patent Application No. 2013-026025 filed on Feb. 13, 2013, the entire contents of which are incorporated herein by reference.

### BACKGROUND OF THE INVENTION

1. Field of the Invention

The present invention generally relates to a disk drive unit, and more particularly to a disk drive unit configured to reduce generation of particles therein.

2. Description of the Related Art

A disk drive unit, such as an HDD (Hard Disk Drive), may be used as a storage unit of a computer or the like. The disk drive unit may include a fluid dynamic bearing that may considerably improve a rotation accuracy of a disk, as described in Japanese Laid-Open Patent Publication No. 2007-198555, for example. Due to the improved rotation accuracy of the disk obtainable by the fluid dynamic bearing, there are demands to further increase the recording density and the recording capacity of the disk drive unit.

Normally, the disk drive unit rotates a recording disk that is formed with a recording track at a high speed using a brushless motor. In order to magnetically record data on and magnetically reproduce the data from the recording track of the recording disk, a recording and reproducing head is arranged with a slight gap from a surface of the recording disk.

The recording capacity of the disk drive unit may be increased by one technique in which a width of the recording track is reduced and the recording and reproducing head is arranged closer to the surface of the recording disk. However, when the gap between the recording and reproducing head and the surface of the recording disk is narrow, foreign particles (hereinafter simply referred to as “particles”) having a diameter of 0.1 μm to several μm and existing in a vicinity of the recording disk may make contact with the recording and reproducing head. When the recording and reproducing head makes contact with the particles while tracing (or scanning) the recording track, energy generated by the contact is superimposed on signals as noise, to thereby deteriorate the accuracy of reading or writing the signals.

Studies made by the present inventors revealed that peeling of micro residue adhered on a processed surface, such as a surface of a hub mounted with the recording disk, may generate the particles. Particularly in the case of a 3.5-inch HDD, the hub may be formed by cutting an aluminum alloy that includes a predetermined percentage of aluminum. In this case, micro residue may peel off from the surface of the hub to generate the particles. Because the hub is exposed in a space that accommodates the recording disk, the particles generated from the exposed surface of the hub may easily adhere on the recording and reproducing head and the surface of the recording disk to cause a failure.

The problem caused by the particles is not limited to the hub made of the aluminum alloy, and the problem may similarly occur in the hub made of materials other than the aluminum alloy.

### SUMMARY OF THE INVENTION

Embodiments of the present invention may provide a disk drive unit that may reduce generation of particles therein.

According to one aspect of the present invention, a disk drive unit may include a base; a hub rotatably supported on the base and including a setting part on which a recording disk is to be set; and a bearing unit having one end fixed to the base and another end holding the hub, wherein the hub includes a cut surface formed by cutting a nonferrous metal or a steel material, and wherein the cut surface includes a surface treatment layer formed thereon and preventing peeling of micro residue adhered on the cut surface.

Other objects and further features of the present invention may be apparent from the following detailed description when read in conjunction with the accompanying drawings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are a top view and a side view, respectively, illustrating a disk drive unit in one embodiment; and

FIG. 2 is a cross sectional view of the disk drive unit along a one-dot chain line A-A in FIG. 1A.

### DESCRIPTION OF THE PREFERRED EMBODIMENTS

In each of the figures described hereunder, those elements and parts that are the same or substantially the same are designated by the same reference numerals, and a description thereof will not be repeated where appropriate. In addition, dimensions of the parts in each of the figures are enlarged or reduced, where appropriate, in order to facilitate understanding of the parts. Further, in each of the figures, illustration of some of the parts that may be considered unimportant in describing embodiments is omitted for the sake of convenience.

A rotating device used in one embodiment may be suited for use in a disk drive unit, particularly in an HDD (Hard Disk Drive) that is equipped with a magnetic recording disk and rotationally drives the magnetic recording disk.

### Embodiment

The disk drive unit in one embodiment may be summarized as follows.

The rotating device of the disk drive unit in one embodiment may include clamp screw holes in a hub. The clamp screw holes may be used to fix a clamper on the hub. This clamper may fix a magnetic recording disk on the hub. The clamp screw holes may be formed by penetration holes. For this reason, the clamp screw holes may be formed with ease. In addition, in the rotating device of disk drive unit in one embodiment, a yoke may be provided to cover an end part of the clamp screw holes on a base side. Hence, an amount of evaporated lubricant flowing to the side of the magnetic recording disk via the clamp screw holes may be suppressed.

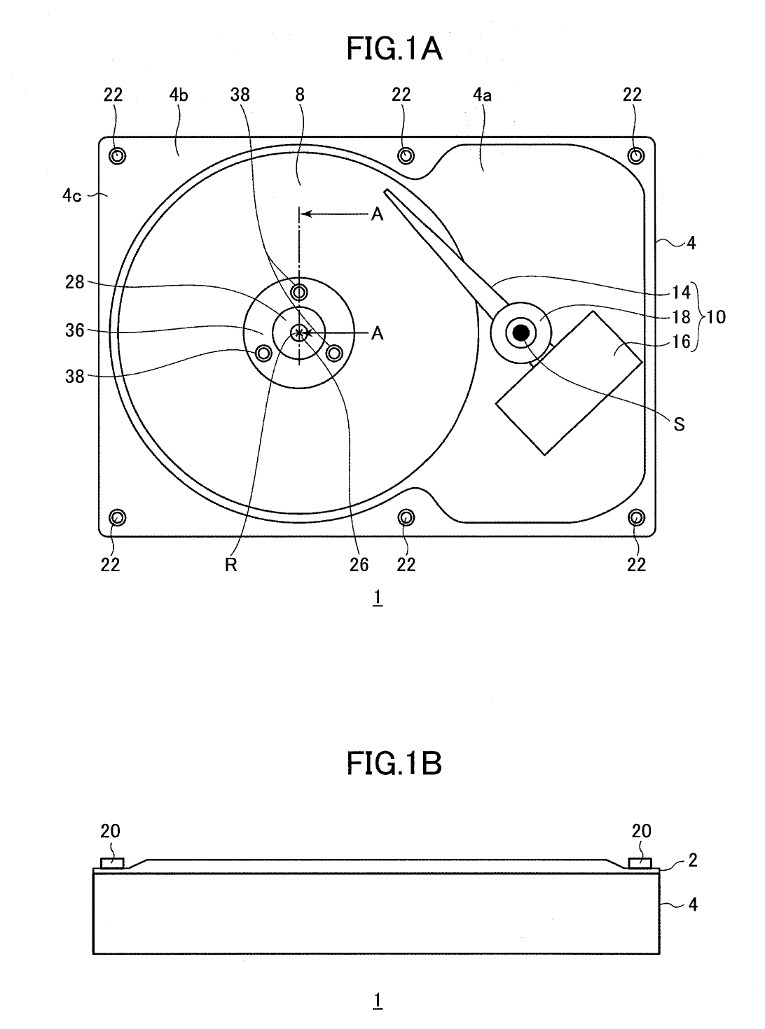

FIGS. 1A and 1B illustrate a disk drive unit 1 in this embodiment. FIG. 1A is a top view of the disk drive unit 1. FIG. 1A illustrates the disk drive unit 1 in a state in which a top cover 2 is removed, in order to illustrate a configuration inside the disk drive unit 1. FIG. 1B is a side view of the disk drive unit 1.

The disk drive unit 1 may include a shaft 26, a hub 28, a clamper 36, clamp screws 38, a magnetic recording disk 8, a data read and write unit 10, a base 4, the top cover 2, and six (6) screws 20.

In the following description, a side on which the hub 28 is provided with respect to the base 4 will be referred to as an “upper side” of the base 4.

The magnetic recording disk 8 may be a 3.5-inch magnetic recording disk having an aluminum substrate with a diameter of approximately 95 mm. The magnetic recording disk 8 may have a center hole with a diameter of approximately 25 mm, and have a thickness of approximately 1.27 mm or approximately 1.75 mm. The magnetic recording disk 8 may be set on a disk setting surface (or setting part) of the hub 28, and rotated together with the rotation of the hub 28.

The clamper 36 may be crimped on an upper surface of the hub 28 by the clamp screws 38, and press the magnetic recording disk 8 against the disk setting surface of the hub 28.

The base 4 may be formed by die casting an aluminum alloy. The base 4 may include a bottom plate part 4a forming a bottom part of the disk drive unit 1, and an outer peripheral wall part 4b formed along an outer periphery of the bottom plate part 4a so as to surround a setting region for the magnetic recording disk 8. Six (6) screw holes 22 may be provided in an upper surface 4c of the outer peripheral wall part 4b.

The data read and write unit 10 may include a recording and reproducing head (not illustrated), a swing arm 14, a voice coil motor 16, and a pivot assembly 18.

The recording and reproducing head may be mounted on a tip end part of the wing arm 14, and record (or write) data on the magnetic recording disk 8 and read (or reproduce) data from the magnetic recording disk 8. The pivot assembly 18 pivotally supports the swing arm 14 with respect to the base 4 so that the swing arm 14 may freely swing about a head rotational axis S as its center of rotation. The voice coil motor 16 may swing the swing arm 14 about the head rotational axis S as its center of rotation, and move the recording and reproducing head to a desired position on an upper surface of the magnetic recording disk 8. The voice coil motor 16 and the pivot assembly 18 may be formed using a known technique to control the head position.

The shaft 26 may extend along a rotational axis R of the hub 28. An upper end of the shaft 26 may be fixed to the hub 28, as will be described later.

The top cover 2 may be fixed on the upper surface 4c of the outer peripheral wall part 4b of the base 4 using the six (6) screws 20. The six (6) screws 20 respectively correspond to the six (6) screw holes 22. Particularly the top cover 2 and the upper surface 4c of the outer peripheral wall part 4b are mutually fixed in order to prevent particle-containing air from leaking into the inside of the disk drive unit 1 from a joining part between the top cover 2 and the upper surface 4c. The magnetic recording disk 8 and the data read and write unit 10 are accommodated within a disk accommodating space that is formed when the top cover 2 is fixed to the base 4.

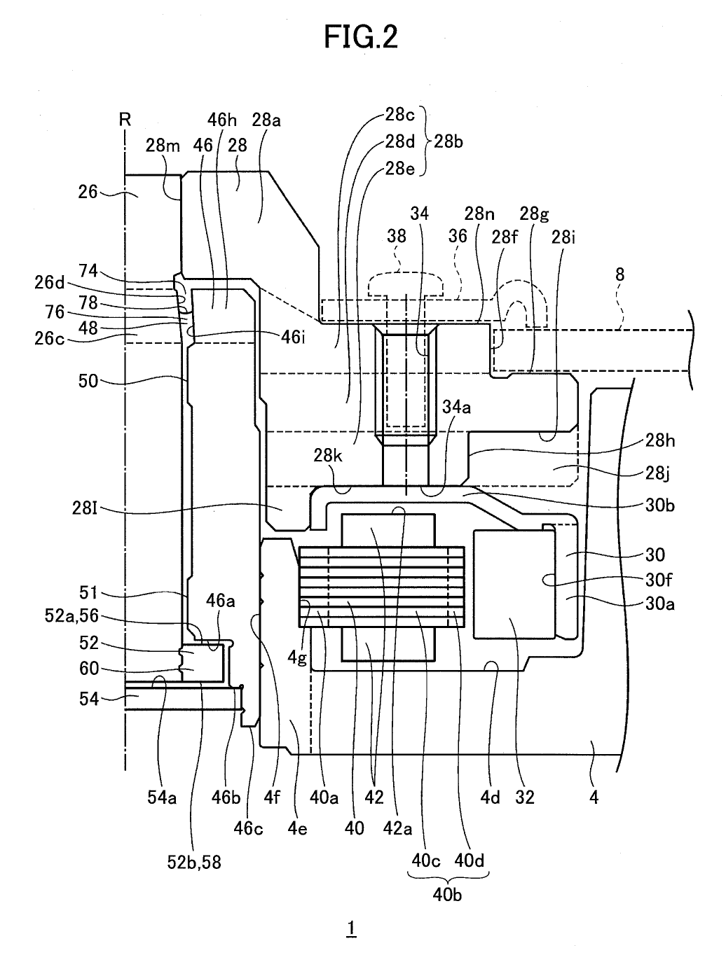

FIG. 2 is a cross sectional view of the disk drive unit 1 along a one-dot chain line A-A in FIG. 1A.

As illustrated in FIG. 2, the disk drive unit 1 may further include a cylindrical magnet 32, a yoke 30, a flange 52, a laminated (or stacked) core 40, a coil 42, a sleeve 46, a plate 54, and a lubricant 48.

The hub 28 in this embodiment may be cut from aluminum or an aluminum alloy and formed into a predetermined shape, which is an approximate cup shape in this example. Accordingly, the hub 28 may have a processed surface formed by the cutting. As an example, an outer peripheral surface of a cylindrical part which fits into the center hole of the magnetic recording disk 8, and the disk setting surface of the hub 28 on which the magnetic recording disk 8 is set, which require high precision, may be formed by the cutting. A part of the cut surfaces may be exposed on the inner side of the disk drive unit 1, that is, exposed to the disk accommodating space. The cut surface of the hub 28 exposed to the disk accommodating space may be subjected to a surface treatment. As a result, the generation of particles from the cut surface of the hub 28 exposed to the disk accommodating space may be suppressed.

The surface treatment to be applied to the cut surface of the hub 28 is not limited to a particular surface treatment. As an example, the cut surface may be nickel plated. In this case, a passive layer on the cut surface of the hub 28 may be removed, an undercoating process may be carried out thereafter, and an electroless nickel plating may be carried out thereafter. According to this method of surface treatment, the adhesion of the nickel plating forming a surface treatment layer may be improved.

An example of the process to form the nickel plating by the electroless nickel plating on the hub 28 formed from the aluminum or aluminum alloy may include the following steps. Aluminum is an amphoteric metal, and aluminum and aluminum alloy dissolve in alkali and acid solutions. In addition, aluminum and aluminum alloy are easily oxidized. For this reason, the hub 28 that is cut is subjected to a degrease cleaning or the like and then etched in order to remove a surface oxidized layer, and micro undulations (or concavo-convex patterns) are thereafter formed on the surface for improving adhesion. Next, the hub 28 is bathed in nitric acid in order to remove impurities on the surface, such as magnesium, for example. Then, a zincate conversion process is carried out to cause zinc to precipitate to the surface of the hub 28. Next, the hub 28 is bathed in nitric acid in order to once remove the zinc precipitated to the surface of the hub 28 in the preceding step, and another zincate conversion process is carried out to cause zinc to again precipitate to the surface of the hub 28. The adhesion of the plating may improve by carrying out the process described above. Then, the hub 28 is dipped in an electroless nickel plating solution in order to substitute the zinc by nickel and cause nickel to precipitate to the surface of the hub 28. Accordingly, the nickel plating process, that includes the bathing in nitric acid and the zincate conversion process as the undercoating process, may form a nickel plating having a thickness of 1 μm to 4 μm, for example, on the surface of the hub 28.

The hub 28 may include a surrounding part 28a that surrounds the shaft 26, a cylindrical part 28b that is provided from a lower end of the surrounding part 28a towards the outer side along a radial direction (that is, a direction perpendicular to the rotational axis R) and surrounds the sleeve 46, and a hub projecting part 28l that projects from a lower surface 28k of the cylindrical part 28b towards the lower side and surrounds the sleeve 46. The cylindrical part 28b may include a medium diameter part 28c at an upper part thereof, and a large diameter part 28d at a lower part thereof at a position below the medium diameter part 28c. The large diameter part 28d may have a diameter greater than that of the medium diameter part 28c. The cylindrical part 28b may further include a small diameter part 28e at a lower part thereof at a position below the large diameter part 28d. The small diameter part may have a diameter smaller than that of the medium diameter part 28c. The medium diameter part 28c and the small diameter part 28e may be replaced by a small diameter part and a medium diameter part, respectively.

An outer peripheral surface 28f of the medium diameter part 28c may fit into the center hole of the magnetic recording disk 8, and the magnetic recording disk 8 may be set on a disk setting surface (or setting part) 28g formed at an upper surface of the large diameter part 28d.

A relief (or cave-in) part 28j, that caves in from a lower end outer edge of the cylindrical part 28b towards the inner side along the radial direction, may be formed by an outer peripheral surface 28h of the small diameter part 28c and a lower surface 28i of the large diameter part 28d. Because a surface of the relief part 28j on the inner side along the radial direction forms the outer peripheral surface 28h of the small diameter part 28e, this surface of the relief part 28j may be located at a position closer to the rotational axis R than the outer peripheral surface 28f of the medium diameter part 28c fitting into the center hole of the magnetic recording disk 8.

Three (3) clamp screw holes 34 may be provided in the cylindrical part 28b around the rotational axis R at 120° intervals. The clamp screw holes 34 may penetrate the cylindrical part 28b in an axial direction, that is, in a direction parallel to the rotational axis R. The clamper 36 may be crimped on an upper surface 28n of the cylindrical part 28b of the hub 28 by the three (3) clamp screws 38 that are screwed into the three (3) clamp screw holes 34, and press the magnetic recording disk 8 against the disk setting surface 28g of the hub 28.

The yoke 30 may be pressed from a plate made of a magnetic material such as iron. For this reason, the yoke 30 may have an embossed surface. The “embossed surface” means that a concavo-convex pattern in accordance with a pressing surface of a press mold may be formed on the surface of the yoke 30. The yoke 30 may be formed to have a thickness in a range of 0.2 mm to 1.0 mm. The yoke 30 may include a cylindrical magnet holding part 30a, and a lid part 30b extending from an upper end of the magnet holding part 30a towards the inner side along the radial direction. The lid part 30b may be formed to cover an end part 34a of each clamp screw hole 34 on the side of the base 4. In addition, the lid part 30b may be formed so that a projection region in an axial direction thereof covers a projection region of the coil 42 along the axial direction thereof. The projection region in the axial direction refers to a region included in a projection made in the axial direction. In other words, the lid part 30b may be formed to oppose the entire upper end 42a of the coil 42 along the axial direction. The lid part 30b may be bonded and fixed to the lower surface 28k of the small diameter part 28e of the hub 28. The lid part 30b may be fixed to the hub projecting part 28l by press fitting, or bonding, or press fitting and bonding. The lid part 30b may be fixed to both the lower surface 28k of the small diameter part 28e and the hub projecting part 28l.

The cylindrical magnet 32 may be bonded and fixed to an inner peripheral surface 30f of the magnet holding part 30a of the yoke 30. The cylindrical magnet 32 may be formed from a rare earth magnetic material, a ferrite magnetic material, or the like, for example. In this embodiment, the cylindrical magnet 32 is made of a ferrite magnetic material. The cylindrical magnet 32 may be provided with eight (8) driving magnetic poles along a circumferential direction thereof (that is, a tangential direction that is tangent to a circle having the rotational axis R as its center, and wherein the circle is perpendicular to the rotational axis R). A surface layer may be formed on the surface of the cylindrical magnet 32 by electro-coating, spray coating, or the like, for example. The provision of this surface layer may suppress corrosion, for example. The cylindrical magnet 32 may oppose twelve (12) salient poles of the laminated core 40 in the radial direction.

The laminated core 40 may include a cylindrical part 40a and twelve (12) salient poles 40b extending from the cylindrical part 40a towards the outer side along the radial direction. The laminated core 40 may be fixed on the side of an upper surface 4d of the base 4. The laminated core 40 may be formed by laminating eight (8) thin magnetic steel plates, and crimping the thin magnetic steel plates in order to integrally form the laminated core 40. A surface layer may be formed on the surface of the laminated core 40 by insulator coating, such as electro-coating, powder coating, or the like, for example. Each of the twelve (12) salient poles 40b may include an intermediate part 40c extending from the cylindrical part 40a towards the outer side in the radial direction, and a tip end part 40d provided on a side of the intermediate part 40c opposite from the cylindrical part 40a. The coil 42 may be wound on the intermediate part 40c of each salient pole 40b of the laminated core 40. A driving magnetic flux is generated along the salient poles 40b when a 3-phase driving current having an approximately sinusoidal waveform flows to the coil 42.

The base 4 may include a cylindrical base projecting part 4e having the rotational axis R as its center. The base projecting part 4e may project to the side of the hub 28 so as to surround the sleeve 46. The laminated core 40 may be press fit, or loosely fit and bonded to the outer peripheral surface 4g of the base projecting part 4e, to be fixed to the outer peripheral surface 4g.

The shaft 26, the flange 52, the sleeve 46, the plate 54, and the lubricant 48 may form a bearing unit that is mounted on the base 4 and rotatably supports the hub 28. An upper end of the shaft 26 may be fixed in a hole 28m that is provided at a center of the hub 28, coaxially with the rotational axis R of the hub 28, in a state in which the upper end of the shaft 26 is press fit and bonded in the hole 28m. The flange 52 may be press fit to a lower end of the shaft 26 and fixed thereto.

The sleeve 46 may be formed by a ring-shaped member, and may be bonded and fixed to an inner peripheral surface of the base projecting part 4e, that is, to a penetration hole 4f that is provided in the base 4 and has the rotational axis R as its center. The shaft 26 may be accommodated in the sleeve 46. The sleeve 46 may include three lower surfaces, namely, an inner side lower surface 46a, an intermediate lower surface 46b, and an outer side lower surface 46c, arranged in this order from the inner side along the radial direction. The intermediate lower surface 46b may be located on the lower side of the inner side lower surface 46a, and the outer side lower surface 46c may be located on the lower side of the intermediate lower surface 46b.

The sleeve 46 may include a sleeve tapered part 46h on an upper end thereof. The shaft 26 may include a shaft tapered part 26c opposing the sleeve tapered part 46h. The sleeve tapered part 46h may surround the shaft tapered part 26c. A tapered seal part 76 may be formed between the sleeve tapered part 46h and the shaft tapered part 26c. A gap 74 between an inner peripheral surface 46i of the sleeve tapered part 46h and an outer peripheral surface 26d of the shaft tapered part 26c, which gradually spreads in the upward direction, may be formed in the tapered seal part 76. Particularly, both the inner peripheral surface 46i of the sleeve tapered part 46h and the outer peripheral surface 26d of the shaft tapered part 26c may have a diameter than decreases in the upward direction, and a tapered shape of the tapered seal part 76 may be formed due to the inner peripheral surface 46i of the sleeve tapered part 46h having a diameter reduction rate that is smaller than that of the outer peripheral surface 26d of the shaft tapered part 26c. When the shaft 26 rotates, a force caused by centrifugal force acts in the outer side along the radial direction with respect to the lubricant 48 within the tapered seal part 76. Because the diameter of the inner peripheral surface 46i of the sleeve tapered part 46h becomes smaller towards the upward direction, the force acting on the lubricant 48 sucks the lubricant 48. In addition, the tapered seal part 76 may include a gas-liquid interface 78 of the lubricant 48, and suppress leaking of the lubricant 48 due to capillarity.

The plate 54 may be bonded and fixed to the intermediate lower surface 46b of the sleeve 46 so as to cover the end part on the lower side of the sleeve 46. A flange space 60 in which the flange 52 may be accommodated, may be formed between an upper surface 54a of the plate 54 and the inner side lower surface 46a of the sleeve 46.

The lubricant 48 may fill a space between the shaft 26 and the flange 52, and a space between the sleeve 46 and the plate 54.

A herringbone-shaped first radial dynamic pressure groove 50 and a herringbone-shaped second radial dynamic pressure groove 51 that are separated in the up-and-down direction may be formed in the inner peripheral surface of the sleeve 46. A herringbone-shaped first thrust dynamic pressure groove 56 may be formed in an upper surface 52a of the flange 52, and a herringbone-shaped second thrust dynamic pressure groove 58 may be formed in a lower surface 52b of the flange 52. When the hub 28 rotates, the hub 28 may be supported in both the radial direction and the axial direction by the dynamic pressure generated in the lubricant 48 by the dynamic pressure grooves 50, 51, 56, and 58. Any of the first radial dynamic pressure groove 50, the second radial dynamic pressure groove 51, the first thrust dynamic pressure groove 56, and the second thrust dynamic pressure groove 58 may be formed to a spiral shape.

At least one of the first radial dynamic pressure groove 50 and the second radial dynamic pressure groove 51 may be formed in the shaft 26. In addition, the first thrust dynamic pressure groove 56 may be formed in the inner side lower surface 46a of the sleeve 46, and the second thrust dynamic pressure groove 58 may be formed in the upper surface 54a of the plate 54.

Next, a description will be given of an operation of the disk drive unit 1 having the configuration described above. In order to rotate the magnetic recording disk 8, a 3-phase driving current may be supplied to the coil 42. When this current flows through the coil 42, magnetic flux is generated along the twelve (12) salient poles 40b. The generated magnetic flux applies a torque on the cylindrical magnet 32, and the hub 28 and the magnetic recording disk 8 fit on the hub 28 rotate. At the same time, the voice coil motor 16 may swing the swing arm 14, in order to move the recording and reproducing head within a swing range on the magnetic recording disk 8. The recording and reproducing head may convert magnetic data recorded on the magnetic recording disk 8 into electrical signals that are supplied to a control board (not illustrated), and write data supplied from the control board in the form of electrical signals on the magnetic recording disk 8 as magnetic data.

According to the disk drive unit 1 of this embodiment, the clamp screw holes 34 are formed to penetrate the hub 28. For this reason, the clamp screw holes 34 may be formed with ease. In addition, foreign particles accumulated within the clamp screw holes 34 during the fabrication process may be removed with ease. Further, the lid part 30b of the yoke 30 may cover the end part 34a of the clamp screw holes 34 on the side of the base 4. Consequently, the amount of lubricant 48 that may flow to the side of the magnetic recording disk 8 through the clamp screw holes 34 and adhere onto the magnetic recording disk 8 as foreign particles may be reduced. In other words, the clamp screw holes 34 may be formed to penetrate the hub 28 in order to improve the productivity, and an increase in read error or write error caused by the penetrating configuration of the clamp screw holes 34 may be suppressed.

Although the embodiments of the present invention have been described in detail, it should be understood that the various changes, substitutions, and alterations could be made hereto without departing from the spirit and scope of the invention.

In the described embodiment, the cylindrical magnet 32 is located on the outer side of the laminated core 40, to form a so-called outer rotor type rotating device. However, the present invention is not limited to the outer rotor type rotating device. For example, the technical concept of the embodiment may be applied to an inner rotor type rotating device in which the cylindrical magnet is located on the inner side of the laminated core.

In the described embodiment, the bearing unit is mounted directly on the base 4. However, the present invention is not limited to such a direct mounting configuration of the bearing unit. For example, a brushless motor may be separately formed from the hub 28, the cylindrical magnet 32, the yoke 30, the bearing unit, the laminated core 40, the coil 42, and the base 4, and this brushless motor may be mounted on a chassis.

The described embodiment uses the laminated core, however, the core is not limited to the laminated core configuration.

In the described embodiment, the base 4 may be formed by die casting an aluminum alloy, however, the method of forming the base 4 is not limited to die casting. For example, the base 4 may be pressed from a metal plate, such as an aluminum plate, an steel plate, or the like. In this case, an embossed part may be provided on the base 4 such that the surface on one side of the base 4 is formed with projections and the surface on the other side of the base 4 is formed with recesses corresponding to the projections. By providing the embossed part at a predetermined portion of the base 4, deformation of the base 4 may be suppressed. In addition, the base 4 having the embossed part may be subjected to a surface treatment, such as plating, resin coating, or the like. For example, after forming the base 4 by pressing the steel plate, a surface layer including a nickel plating and an epoxy resin layer may be provided on the base 4.

The base 4 may be formed by a combination of a metal plate part that is formed by pressing the metal plate, such as the aluminum plate, the steel plate, or the like, and a die cast part that is formed by aluminum die casting. For example, the bottom plate part 4a may be formed to include the metal plate part, and the outer peripheral wall part 4b may be formed to include the die cast part. By employing this combination configuration, rigidity deterioration of the screw holes 22 may be suppressed. In this case, the die cast part may be formed by the aluminum die casting in a state in which the preformed metal plate part is set in a die that is used for the aluminum die casting. According to this method of fabricating the base 4, a process to connect the metal plate part and the die cast part may be omitted, and a dimension accuracy of the metal plate part and the die cast part may be improved. Further, a separate part or member used to connect the metal plate member and the die cast part may be reduced or eliminated, and as a result, the base 4 may easily be made thin.

In the described embodiment, the hub 28 may be formed by providing nickel plating on aluminum or an aluminum alloy, however, the present invention is not limited to such a configuration. For example, a nickel plating may be formed on a hub made of brass or a copper alloy by electroless nickel plating. Copper alloys such as brass are less easily ionized compared to nickel, and nickel may not easily precipitate to the surface of the hub. For this reason, a noble metal catalyst such as palladium may be added to enable the nickel plating. First, the hub 28 that is cut and subjected to a degrease cleaning or the like may be bathed in alkali in order to remove a surface oxidized layer on the surface of the hub 28. Next, the hub 28 may be dipped in a palladium catalyst solution, for example, in order to adhere a noble metal that becomes the catalyst on the surface of the hub 28. Then, the hub 28 may be dipped in an electroless nickel plating solution in order to precipitate nickel to the surface of the hub 28 by the action of the catalyst. As a result of the above process, a nickel plating having a thickness of 1 μm to 4 μm, for example, may be formed on the surface of the hub 28.

In the described embodiment, the hub 28 made of a nonferrous metal may be plated, however, the present invention is not limited to such plating. For example, the hub 28 may be bathed in sulfuric acid and a current may be applied to the hub 28, using the hub 28 as an anode, in order to form an alumite layer having a thickness of 5 μm to 20 μm, for example. In addition, an ED (Electrical Discharge) coating, such as cation electrocoating, may be carried out to form a resin coating layer on the hub 28. Alternatively, the surface treatment of the hub 28 may include, according to specifications of the product, a conversion coating process such as electroless nickel plating with fluorocarbon resin (polytetrafluoroethylene), various trivalent chromate galvanizing, nickel-zinc alloy plating, cation electrocoating on galvanized layer, zinc phosphate treatment, or the like.

Arbitrary combinations of the constituent elements described above, and substitutions among the constituent elements in a method, an apparatus, a system, and the like may form embodiments of the present invention.

According to the embodiments and modifications, it is possible to provide a disk drive unit that may reduce generation of particles therein.

What is claimed is

1. A disk drive unit comprising:
a base;
a hub rotatably supported on the base and including a setting part on which a recording disk is to be set; and
a bearing unit having one end fixed to the base and another end holding the hub,
wherein the hub includes a cut surface formed by cutting a nonferrous metal, and
wherein the cut surface includes a surface treatment layer formed thereon and preventing peeling of micro residue adhered on the cut surface.

2. The disk drive unit as claimed in claim 1, wherein the cut surface includes micro undulations that are formed after removing a surface oxidized layer by etching.

3. The disk drive unit as claimed in claim 1, wherein the surface treatment layer includes zinc precipitated to the cut surface by a zincate conversion process.

4. The disk drive unit as claimed in claim 1, wherein the surface treatment layer includes a metal plating.

5. The disk drive unit as claimed in claim 1, wherein the surface treatment layer includes a nickel plating.

6. The disk drive unit as claimed in claim 1, wherein the hub is made of aluminum or an aluminum alloy, and the surface treatment layer includes an alumite layer.

7. The disk drive unit as claimed in claim 1, wherein the surface treatment layer includes a resin coated layer.

8. A disk drive unit comprising:
a base;
a hub rotatably supported on the base and including a setting part on which a recording disk is to be set; and
a bearing unit having one end fixed to the base and another end holding the hub,
wherein the hub includes a cut surface formed by cutting a steel material, and
wherein the cut surface includes a surface treatment layer formed thereon and preventing peeling of micro residue adhered on the cut surface.

9. The disk drive unit as claimed in claim 8, wherein the cut surface includes micro undulations that are formed after removing a surface oxidized layer by etching.

10. The disk drive unit as claimed in claim 8, wherein the surface treatment layer includes zinc precipitated to the cut surface by a zincate conversion process.

11. The disk drive unit as claimed in claim 8, wherein the surface treatment layer includes a metal plating.

12. The disk drive unit as claimed in claim 8, wherein the surface treatment layer includes a nickel plating.

13. The disk drive unit as claimed in claim 8, wherein the surface treatment layer includes a resin coated layer.
